(19) United States
(12) Patent Application Publication
(10) Pub. No.: US 2010/0275271 A1
(43) Pub. Date: Oct. 28, 2010

(54) Form Production System

(76) Inventors: Peter Thomas Smith, Wollstonecraft NSW (AU); Donald Wallis Trent, Balgowlah Heights NSW (AU)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/831,902

(22) Filed: Jul. 7, 2010

Related U.S. Application Data
(63) Continuation of application No. 11/400,152, filed on Apr. 7, 2006, now abandoned.
Application No. 11/400,152 is a continuation of application No. 10/221,805, filed on Nov. 25, 2002, now abandoned.

(30) Foreign Application Priority Data
Mar. 17, 2000 (AU) PR0677
May 29, 2003 (AU) 2003902661

(51) Int. Cl. G06F 21/24; G06F 17/00; G06F 3/12; G06K 15/02

(52) U.S. Cl. 726/30; 715/202; 358/1.15; 358/1.11; 715/274

(57) ABSTRACT

The present invention relates to an on-line system for facilitating the production of forms, such as business cards, stationery, catalogues and generally any printed matter. Relatively permanent material for the production of forms is stored as a form structure in a computing system repository. The system receives copy information input by a user and combines it with the form structure to produce a finished artwork which is transmitted to a printery.

### FIELD OF INVENTION

The present invention relates to a system for facilitating the provision of forms and, particularly, but not exclusively, to a system for facilitating the provision and procurement of forms on-line.

### BACKGROUND OF INVENTION

The provision and procurement of forms for any entity (the entity may be an individual or an organisation such as a company) is a complex matter which requires a number of steps, including form formulation (involving design processes) and procurement from a form provider (usually a printery). Forms must usually have some consistency of appearance, e.g. branding information, but also some variety in appearance (e.g. business cards will include branding information but also details specific to the particular individual who is to own the business card).

The term “forms” includes any matter which is intended to be printed and requires an artwork to be produced to enable the printing to be effected. Forms include, but are not limited to, business cards, business stationery, letter heads, bill boards, fliers, advertising material, etc. “Forms” essentially includes all matter the production of which requires the preparation of an “artwork” to enable the form to be printed, usually by printery (acting as the form provider).

Presently available systems for the provision of forms are primitive and require much manual intervention. Usually, a company that wishes to procure forms will employ a designer to design the forms, and once the design has been established, the designer will liaise with a printer to prepare artwork so that the forms can be printed. Any form will usually include relatively permanent matter (such as company logos, company branding, pictorial design matter, etc.) that does not need to be varied. They also may include “copy” information which may vary from form to form. For example, business cards usually include company logos which are consistent for all the business card owners in an organisation, and copy material which is specific to a particular business card owner (e.g. name, address, and other personal details). As well as the design of the relatively permanent material, it is also necessary to settle the copy information before the final artwork is produced. This is a process which requires the exchange of much information between the company, the designer and the printer. The process can therefore result in many errors, and the consumption of many hours of time.

In the case of business cards, for example, firstly the general design of the business card must be settled by the designer, on consultation with the ordering company. This can involve a long process of consultation with the company, preparing draft artworks for review and approval by company managers. Copy material must then be obtained from the company managers, who will usually need to consult with staff members to find out exactly what they want on their personal business cards. Completed artwork for each individual card is then passed to the printery (usually a separate organisation) to produce final output. Much of this process is manual (i.e. consultation with the management, consultation with the staff members, approval by the management, approval by the staff members, etc.).

Additionally, every time a staff member runs out of cards, every time a new staff member joins a company, every time a staff member wishes to change what they have on their cards, the process must be repeated. Usually, only copy material will be required in the circumstances, but it is still necessary to go through the process of producing a new, finished artwork so that the printery can print the business cards for the staff member.

The actual cost of printing business cards is small compared to the overall cost of ordering, approving and purchasing the product. The present manual process for obtaining business cards, raising the order, re-keying of data, proofing and approval, follow-up, inquiry and delivery, all add to the cost of business card production. It is believed that these “hidden” overheads can range between two to four times the actual purchase price of the cards themselves.

These problems do not just occur with the provision of business cards, but with the provision of many forms.

These problems are not just problems for the company ordering the forms (although the cost is usually passed on to them), but also problems for the designer and the printer involved. Many man hours are wasted in the manual design and requisition procedure.

### SUMMARY OF INVENTION

The present invention provides a system for facilitating the provision of forms, comprising a service computing system, remotely accessible by a plurality of user client systems, and including memory means storing a plurality of form structures for generating forms for a plurality of users, a user client interface enabling input of copy information, and means for producing an artwork from the input copy information and a form structure, the artwork being available for production of a form, wherein the form structure comprises relatively permanent material stored as data and commands within fields in the database, and wherein means are provided for taking the copy information input by the user and producing copy data to be input into further fields in the database, the means for producing the artwork including artwork application means for processing the data and commands and copy data from the database to produce finished artwork.

A form structure preferably provides matter which is relatively permanent. For example, where the form is business stationery, a business card, business envelopes, the form structure may provide business logos and other branding type material. The relatively permanent material provided by the form structure may be useable a number of times, e.g. with business cards the material provided by the form structure can be used to produce all the company's business cards, along with specific copy material for each individual owning the cards. It is possible, however, that a form structure may include material which is only intended to be used once, but which requires input of copy information by a user in order to prepare copy material to produce finished artwork. Generally, however, a form structure is intended to be used more than once with varying copy.

Note that the artwork will preferably be produced in a final form which is useable by a printer.

The copy information, preferably includes material (usually, but not exclusively, textual) which may need to be updated from time to time, e.g. user name and qualifications (for business cards), addresses, marketing bulletins, etc.

Note that the copy information may also include control information for controlling input of the copy, and preferably for controlling appearance of the copy.

With presently known software applications such as word processing packages, relatively permanent material providing a basis for a finished document may be stored as a “template”. For example, a template may include relatively permanent matter such as logos and letter head information, and provide a series of fields into which text can be typed. The template will usually take up at least a page of document. Preferably, in the present invention the form structure is provided in the form of data, preferably including data indicative of reference points in space (defining where artwork material is to be placed in an artwork) and data indicative of artwork material for inclusion in the artwork or referring to files storing matter for inclusion in the artwork. The means for producing the artwork preferably includes an artwork application that takes the data and any commands which may also be provided in the data, and produces the artwork. The form structure, therefore, is stored as data and commands in a plurality of data fields in a database. Preferably, the database also includes fields in which data (and, preferably, commands) indicative of copy material may be input in response to user input via the client interface. The, the application software then runs on the data and commands which have been completed by input from the user, to produce the finished artwork.

This is a totally novel way of producing an artwork or any document. It allows for great versatility, as it is a simple matter to change which matter is to be maintained relatively permanently in the database (the form structure) and which can be added by a user as copy information to go into fields to be completed in the database, before the artwork application is run.

Note that, where a database is used to store data and commands to produce the finished artwork, the database may initially be empty and the user will be required to input all data to produce the finished artwork. In the limit therefore, the term “form structure” includes a database as discussed above which is available to receive all the information and commands to produce a finished artwork.

Preferably, the plurality of user client systems may be associated with different entities, e.g. different corporations, or different departments within the same corporation. The service computer system is also preferably operated by a separate entity, either a separate department within a corporation or a separate company providing a form preparation service to the user client entities.

The service computing system and the user client systems may be connectable via a computer network. In a preferred embodiment, system interaction is via a wide area network (WAN) such as the Internet. The service computing system preferably includes a server computer which provides a Website enabling access to the system. A user client system preferably includes a browser for accessing the server computer Website.

Preferably, therefore, the system of the present invention may provide a service to any entity (organisation, individual) that has a need for forms (this will include most entities). The general design of a particular form is agreed on with a designer. The form structure is then prepared for storage within the service computer system memory. The form structure is preferably in the form of information stored or referenced in fields of a database which, when the means for producing the artwork is applied is processed to produce the relatively permanent artwork material (as discussed above, the artwork is preferably not produced until the copy data has been input into the database. The data for the form structure and data for the copy material is then processed together to produce the final artwork). Note that this design process can be carried out on-line. Relatively permanent material could be input into the database on-line by a user entity using the service computing system. This would then be available for further input of varying copy-material from time to time by the user entity. Each user entity has access to the service computing system (preferably via a Website) sufficient to enable input of copy information to combine with the form structure associated with the entity to produce a finished artwork for production of the form for that entity.

The service computing system is also preferably connectable to or accessible by one or more printer client systems, which are preferably able to access a completed artwork and use it to carry out a print run to produce the forms for use by the user entity.

The printer client systems may preferably be associated with separate printer entities (i.e. separate printeries) which can access the service provided by the system of the present invention. Such an arrangement enables a user entity to select the particular preferred printer for producing forms from the finished artworks. Note that any printing technology can be used to print the forms, e.g. laser printers.

The service computing system also preferably includes requisition means which enable orders to be placed by users for e.g. particular amounts of forms to be printed. The requisition means is preferably accessible by the printer client system so that the order can be automatically obtained by the printer. The requisition details can also preferably be accessed by relevant departments of the user, (e.g. accounts, requisition department, etc.) so that an order can be monitored, approved and settled.

The system of the present invention has the advantage, therefore, that, in the preferred embodiment, the finished artwork can be prepared directly from user input to a computing system, preferably web-enabled. The finished artwork can then be provided directly to a printer for printing. Preferably, before being provided to the printer, the finished artwork is approved by the user. In addition, the associated requisition system enables orders to be followed through the system.

Computer packages are known which enable the design of artwork. These packages do not work on the basis of a pre-stored form structure. Nor do they allow for user input on-line. The user input is as conventional, i.e. discussions with the designer and providing information in the form of hard copy or e-mails to the designer so that the designer can incorporate this information in the artwork he is designing on the computer package. Present computer packages, therefore, are more in the nature of design systems, than systems for facilitating the production and ordering of forms and other related work flow aspects.

One of the difficulties encountered in producing the finished artworks in an on-line environment, as discussed above, is the production of an artwork having different fonts on the same line, or having fractional fonts. Preferably, the system of the present invention provides a means for enabling the production of fractional fonts on the artwork, or different fonts on the same line, in response to copy information input by the user. Preferably, the copy information includes control information for controlling the font. In the preferred embodiment, this control information is loaded in the appropriate field(s) in a database for processing by the artwork application to produce the finished artwork.

When a form is being printed, printing will be carried out on a substrate, which may be paper, card, material (e.g. for T-shirts), etc. In order to make the most efficient use of the available material, the printer must match size of the form with the size of the material substrate to ensure that as much of the material is used as possible. For example, if the form is a business card, and it is to be printed on A4 card substrate, it will be necessary to print, say, 8 business cards per A4 card substrate (“8 up”). Matching the size of the forms with the size of the substrate to provide the most efficient use of material is known as “imposition”. Imposition must also take into account the cutting machine which is to be used to cut the substrate into the separate forms. Imposition is usually carried out by a printer and can be a complex process to match with a particular order amount to make the most efficient use of a material, and is another time consuming aspect of the conventional processes for producing forms.

Preferably, the system of the present invention includes imposition means for providing imposition information with the finished artwork. The finished artwork preferably, therefore, comes complete with imposition provided by the imposition means. For example, in the case of business cards, the finished artwork will come with all the artwork for each of the cards in a, say, 8 up form artwork with the correct distances between each of the cards to allow for cutting lines.

Preferably, the imposition means is provided with data on the cutting machine used by the particular printer that the order has been placed with by the user. From this data and from the knowledge of the size of the form and the material substrate which is to be printed, imposition is effected.

Preferably, the imposition means automatically imposes an artwork on an imposition plan when it knows the number of the forms which are to be ordered. The imposition means may also impose further artworks on a single substrate, e.g. different business cards for different people, to make the most efficient use of materials.

The present invention further provides a method of facilitating the provision of forms, comprising the steps providing a service which pre-stores form structures for use in production of artworks for forms, on input of copy information from users of the service.

The method of this aspect of the present invention may utilise the system discussed above.

The present invention further provides a system for facilitating the provision of forms, comprising a service computing system for producing finished artworks in response to user input, the computing system being accessible over a network by user client system for input of user information to enable the system to prepare the finished artwork.

Preferably, the system is also accessible over a computer network by printer client systems to enable the finished artwork to be utilised by a printer to produce printed forms.

Preferably, access to the service computer system is via a network such as the Internet.

The provision of a service for producing finished artwork which can be accessed via a network such as the Internet provides convenience and avoids the wastage of prior art manual systems.

Preferably, the service computer system stores form structures which have been predetermined (preferably settled between the service and the users).

The system of this aspect of the invention may include any or all of the features of the aspects discussed above.

The present invention further provides a method of facilitating the provision of forms, including the steps of utilising a wide area network such as the Internet to provide a service which enables finished artworks to be produced from information input by a user client over the network.

The method also preferably comprises the steps of utilising the network to enable the finished artworks to be accessed by a printer for printing the forms.

The method also preferably comprises the steps of using the network to requisition an order and, preferably, to follow an order.

This aspect of the present invention may utilise any or all of the aspects of the invention discussed above.

The present invention yet further provides a system for facilitating the provision of forms, comprising a computing system including a memory storing a form structure, a user interface means enabling a user to input copy information, and means for producing an artwork from the input copy information and the form structure.

This aspect of the present invention may include any or all of the features of the aspects discussed above.

The present invention further provides a method of producing an artwork, comprising the steps of providing a form structure, the form structure comprising relatively permanent material stored as data and commands within fields in a computer database, adding copy material to the form structure by inputting copy data into further fields in the database, and then processing data and commands and copy data to produce a finished artwork including the copy material and relatively permanent material.

Please note that the terms “relatively permanent material” and “copy material” should be considered very broadly as material which is intended to be relatively permanent (and therefore becomes relatively permanent material) and material which is to be input by, for example, a user (and hence becomes copy material). It can be any visual material. The invention as such allows a form structure to be set up as data and commands in a database which can be used repeatedly to input copy material, the combination can then be processed to produce different artworks repeatedly.

This aspect of the present invention may include any or all of the features of the aspects discussed above.

The present invention further provides a system for producing artwork, comprising a computing system storing a form structure comprising relatively permanent material stored as data and commands within fields in a database, and means for inputting copy material to the form structure in the form of copy data to be input into further fields in the database, and an artwork producing application for processing the data and commands and copy data to produce finished artwork including the copy material and relatively permanent material.

This aspect of the present invention may include any or all of the features of the aspects discussed above.

The present invention further provides a method of producing an artwork, comprising the steps of providing a form structure comprising a computer database available to receive data and commands, and artwork application means arranged to process the data and commands to produce a finished artwork.

Preferably, the form structure can be accessed on-line over a network in order to enter data and commands from a remote location.

The present invention yet further provides a system for producing an artwork, comprising a computing system storing a form structure comprising a database available to receive data and commands, and an artwork application means arranged to process the data and commands to produce a finished artwork.

Preferably, the database is accessible on-line over a network to enable a remote user to input data and commands for producing the finished artwork.

### BRIEF DESCRIPTION OF THE DRAWINGS

Features and advantages of the present invention will become apparent from the following description of an embodiment thereof, by way of example only, with reference to the accompanying drawings, in which:

FIG. 1 is a schematic diagram illustrating a system in accordance with an embodiment of the present invention;

FIG. 2 is representation of a database storing data and commands providing a form structure, which may be employed by a system in accordance with the embodiment of FIG. 1;

FIG. 3 is a representation of an interface display which may be employed by the system to obtain copy information from a user;

FIG. 4 is a representation of a finished artwork which may be produced by the system of FIG. 1;

FIG. 5 is a representation of an imposition artwork which may be reproduced by the system of FIG. 1;

FIG. 6 is a work flow diagram showing work flow which may occur utilising a system in accordance with FIG. 1;

FIG. 7 is an organisational management plan for a service which may utilise the system of FIG. 1, and

FIG. 8 is a schematic diagram of a further embodiment of a system in accordance with the present invention.

### DESCRIPTION OF PREFERRED EMBODIMENT

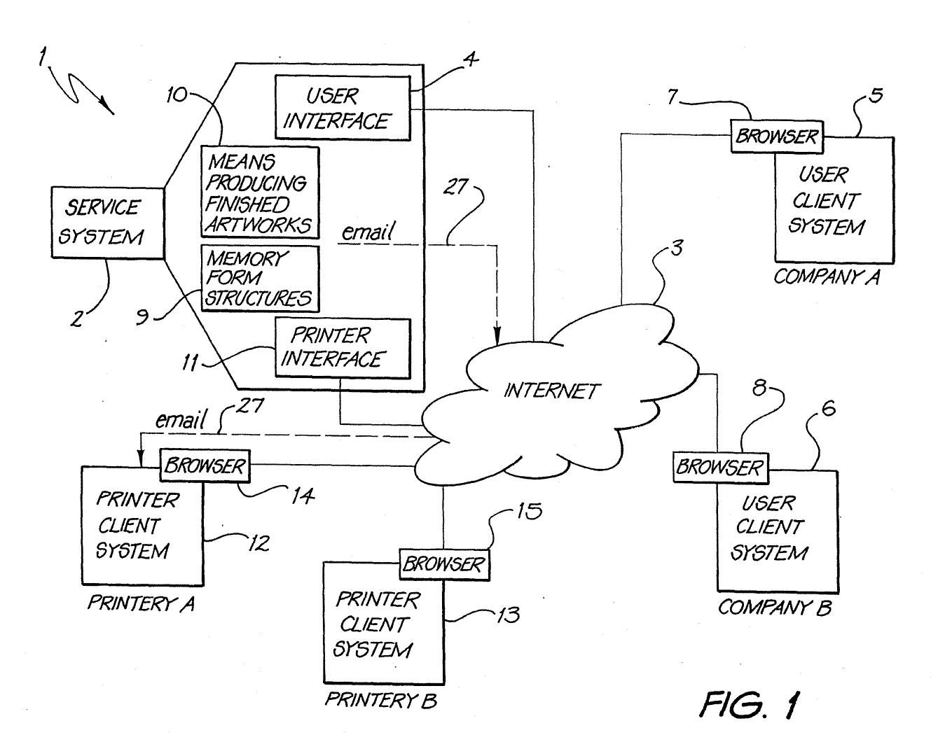

Referring to FIG. 1, a system 1 for facilitating the provision of forms comprises a service computing system 2 for implementing the system. The service computing system 2 may comprise any type of known hardware architecture, e.g. PC, a network of computers, main frame and terminals, etc. In this particular embodiment, the service computing system acts as a server for serving Web pages to the World Wide Web so that Web pages can be accessed via the Internet 3.

The service system 2 includes a user interface 4 (in this embodiment being in the form of a Web page or Web pages accessible by an appropriate browser), the user interface being accessible by users via user client systems 5, 6 (of which there may be many) utilising user client system browsers 7, 8.

The service computing system 2 also includes a memory 9 storing form structures for use by a user; a means for producing finished artworks (which is in this embodiment a software application running on the service computing system 2) from copy information input by a user via the user interface and from a form structure from the form structure memory 9.

In this embodiment, the service computing system 2 also includes, a printer interface 11 (in this embodiment in the form of Web pages accessible by an appropriate browser) which can be accessed by a printer via printer client systems 12, 13 (of which there may be many) having browser software 14, 15.

A printer may access completed artworks in order to print finished forms to provide to a user who has ordered a number of forms.

The following example relates to the requisition and production of business cards by a user, but it will be appreciated that the system of the present invention may be used for the production of any type of form.

In order to utilise the present system to provide business cards, the user (which may be a company that wishes to use the service, or a department in a company where the service is set up as a separate department within the company itself e.g. for large companies), firstly, establishes a relationship with the service. The service provides a framework by which end user clients can create artworks on-line. In the business card example, the more “permanent” features of the business card, such as company logo, other branding features, any aesthetic pictorial information on the card, are loaded into the framework (preferably a database for receiving commands and data). This can be done by the user client on-line, or can be set up by the service. The form structure in this example therefore includes artwork material which is relatively permanent in nature, e.g. is likely to be used more than once to produce an artwork. In the case of a business card, for example, the relatively permanent material may include company logos and branding information. Copy material then may be input on-line by the end user client (e.g. name, address of an individual accessing the system) to add to the relatively permanent material in order to produce a finished artwork.

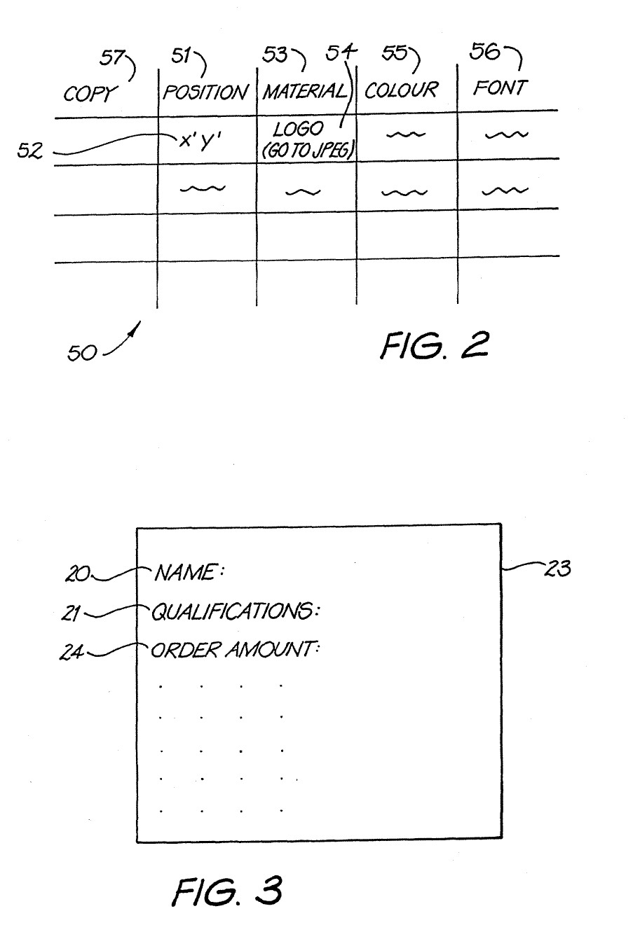

FIG. 2 shows a representation of a database storing data and commands providing a form structure. Relatively permanent material is pre-stored as data and commands in the database 50. For example, one field head 51 includes coordinate data by which material is to be inserted into the final artwork. This data may be provided in the form of coordinates relative to a starting point 0, e.g. X, Y coordinate data 52. Another field head 53 designates fields containing material data. Field 54, as an example, contains a reference to a jpeg which is stored in a location to which the artwork application will go and fetch in response to accessing field 54. The logo will then be placed in the position on the finished artwork which is designated by the position data in field 52. Other fields may include colour 55 and font 56. The database also includes copy fields 57 for entering copy data. The form structure which is stored in the memory 9 in the service system 2, essentially consists of the database including all the data and commands required to produce the relatively permanent material, but none of the data and commands (copy text data) required to produce the copy material on the finished artwork. This data is entered in the database 50 in response to the user entry of copy information via the user interface 4. The final artwork is then produced by the artwork application (see later) from process commands and variable commands and data.

Note that FIG. 2 is a schematic representation of an example database only. It will be appreciated by a person skilled in the art of software programming that the database is likely to be more complex than this. FIG. 2 is given for the purposes of illustration only, and from this a person skilled in the art will be able to provide an appropriate database for use with this embodiment of the present invention.

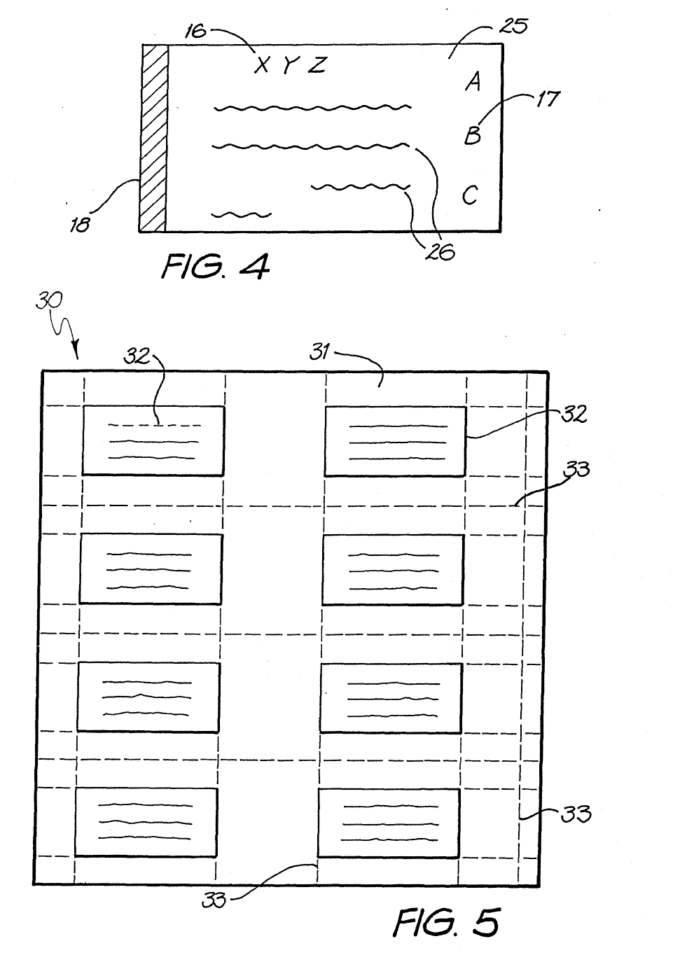

Referring to FIG. 4, which shows a representation of a finished artwork produced by an artwork application software processing the data in the database 50 (after copy data has been input to the database 50), company logo 16 and 17 and band of shading 18, which may, for example, be shaded in the same colours as the company's branding, are produced from the form structure data in the database 50. These, therefore, are the relatively permanent material in this example. This relatively permanent material is stored at the service system 2 in the form of the form structure in the database 50.

If the user runs out of a card for a particular person or persons, the system of the present invention is then used to order replacement cards from printers. In operation, the user (who may be a requisition's officer, but who is preferably the owner of the card themselves) accesses the user interface 4 via the user client system 5 and browser 7 (company A). A screen such as illustrated in FIG. 3 may be presented to the user, to ask him to fill in the details of copy information that need to be filled into the fields, such as, for example, name 20 and qualifications 21. Other copy information 23 may also be requested.

In the preferred embodiment, the system of this embodiment of present invention also accesses an automatic ordering and requisition system. The option is allowed, therefore, by the user interface 4 for the user to input the order amount (e.g. number of business cards required) in a field 24 provided in the interface. Other fields may be provided in the Web page interface for filling in other information associated with requisition and order. The present system not only acts to provide artworks, but also to coordinate requisition and orders.

Once the information has been filled in by the user, the system 2 processes the information via the means for producing artworks 10 to produce a final artwork. The final artwork 25 for this example a business card, is illustrated in FIG. 4. As well as the permanent information 16, 17, 18, copy 26 is now also included in the finished artwork 25. The means for producing artworks 10 includes an artwork application, preferably in the form of software, which processes the data and commands in the database 50 (including the input copy data) to produce the final artwork 25.

The final artwork is displayed to the user via the user interface for approval. Once approval has been given, the order is queued to the printer interface 11 for a particular printer client system 12 (owned by the printery A which is the usual printery that company A uses). All the order information that the printer requires has already been provided by the user via the user interface 4, and all that remains is for the printer client system 12 to access the artwork via the printer interface 11 and browser 14 and make a plate from the process produce the number of finished items that have been ordered by the user.

To further facilitate the process, the service computer system 2 may automatically generate an e-mail 27 to the printer client system 12 advising that a new “job” has been queued at the printer interface 11.

Once the order has been fulfilled, the system may also allow for confirmation from the printer client system 12 to the service computing system 2 so that the user client system 5 can confirm that the order has been carried out, for internal audit and billing purposes.

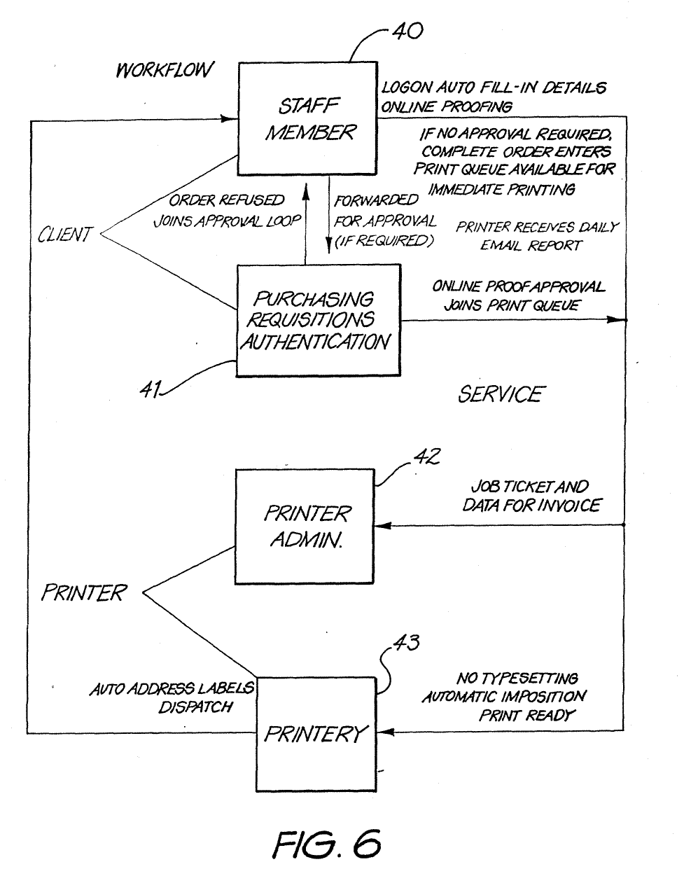

As discussed in the preamble of this document, for a printery to make efficient use of substrate material for producing forms an imposition process is required, which involves mapping the finished artwork to the substrate to make the most efficient use of the available space and still allow for cutting lines which the cutting machine is to follow to produce the final item. In the present embodiment of the present invention, the service computing system 2 also includes imposition planning means (not shown in the drawings), comprising suitable software for providing an imposition plan for a particular finished artwork. FIG. 5 illustrates a possible imposition plan for the artwork of FIG. 4, for producing business cards. The imposition plan 30 comprises a representation of a card substrate 31, and business card representations 32 layed out in an “8 up” format. Cutting lines 33 are imposed on the plan for a cutting machine to follow, in order to divide the substrate into the individual business cards.

In the present embodiment, the final artwork is preferably produced as an imposition plan as illustrated in FIG. 5. The database 50, illustrated in FIG. 2, also includes imposition data. When the artwork application runs, not only does it produce the final artwork for the business card, but produces it as an imposition artwork as illustrated in FIG. 5. The imposition planning mean of this embodiment therefore includes imposition data in the database 50 and part of the artwork application in dealing with the imposition data.

The service computing system 2, has access to data on the size of the substrate which is to be used for a particular finished artwork and the size of the item which is to be produced from the particular finished artwork. Using this data, the imposition planning means can plan the most efficient imposition plan. The database may also include data on the type of cutting machine used by a particular printery, for use in producing the imposition plan.

The service computing system of this embodiment of the present invention, therefore, provides a complete solution to the printery. They receive the finished artwork already in imposition format, which can be used directly to drive the cutting process, making most efficient use of the materials available to the printer.

Another advantage of the service computing system 2 of this embodiment of the invention is that it enables a user to control the provision of fractional fonts and different fonts on the same line of a finished artwork.

Generally, all font information is held within the database 50, by the service computer system 2. Fields within the database determine the characteristics of what will appear as an output used to construct the final artwork. The database holds this information as a stream of data. The selection of default font, size, spacing and alignment for each field is set up within the database. From that point, characteristics can be modified by the action of control information.

When an output is created, the program sets the output characteristics from the specified defaults.

Then the data from the database is examined for control information. If no special formatting has been placed in the data, the entire stream is output.

If, in evaluating the data, special formatting is detected, the initial part of the data stream, up to but not including the point where the special modification commenced, is output. The application then analyses the special instruction characteristics.

Special formatting instructions that do not affect the position of the data are acted upon and passed through to the output.

Instructions that result in modified data position, such as changes to font and size, cause the data to be read in chunks, bounded by the inserted formatting instructions.

Each chunk is read and the characteristics are determined from it. The offset of the chunk is determined from analysis of the positional length of prior output data. Then the data is output.

The process continues until all of the data in the field has been evaluated in output, and all fields have been iterated over.

In this embodiment, the user can affect information held within the database by inputting control information, to produce, for example, fractional fonts, and different fonts on the same line of an artwork or that information can be included as the form structure (unaffected by user input).

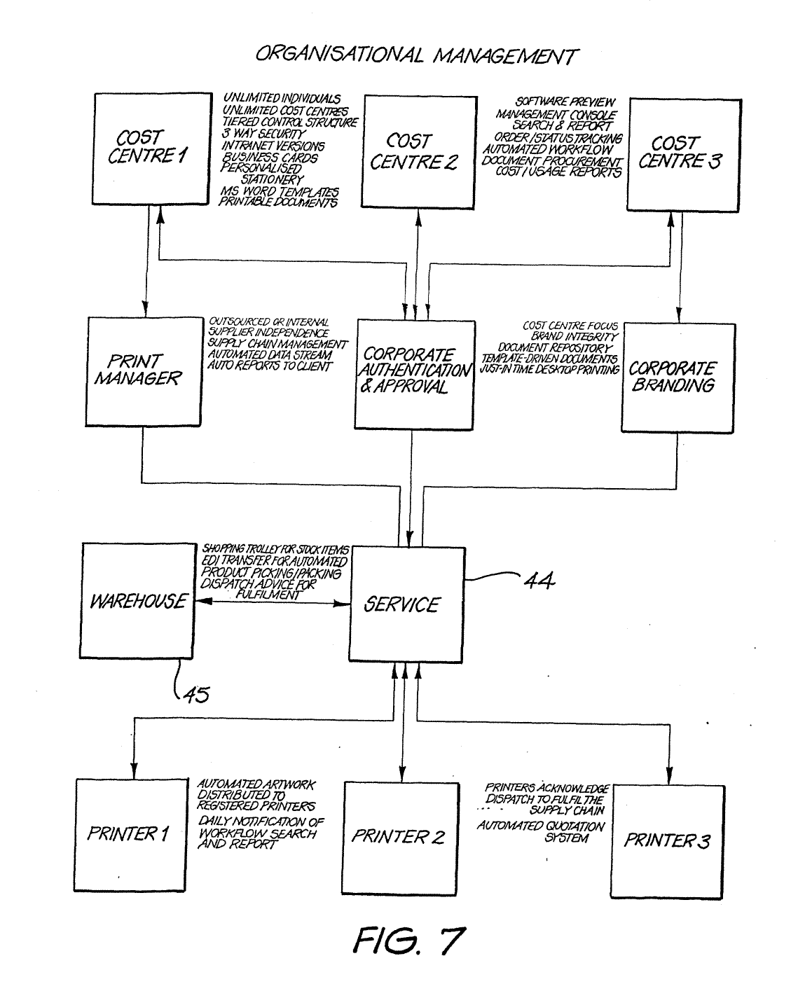

The system of the present invention provides a much improved work flow for the form providing process. An example work flow is illustrated in FIG. 6. A staff member 40 of a client of the service may require business cards. He logs on to the service computing system 2 and fills in the copy details required. The system will then, depending on corporate rules set up in system, also forward to a requisition's office 41 within the client organisation for approval of an order of business cards. Once approval by the staff member and requisition's department has been given, the artwork in the form of an imposition plan is provided to the printer. The printer administration department 42 receives the job ticket and order data for the generation of an invoice and the printery 43 receives the finished imposition artwork ready for platemaking and printing. Printing and preparation of the finalised forms are prepared and dispatched to the client. All this is done without any (or minimal) manual intervention, on-line over a network.

FIG. 7 illustrates an organisational management plan utilising the service 44 in accordance with the present invention. Note that the system may also provide for requisition of stock items (for material substrates, for example) from a warehouse 45.

As discussed above, requisition details of the user printer order may be provided to the user company system so that the user company can track the order. This may be done automatically. In the preferred embodiment, the user company system is integrated with the order process so that information which is available on the company system can be utilised to facilitate the print order.

In one preferred embodiment, information gathering means is arranged to access the user company system to obtain data which may be used for copy information, and automatically provide that data to the service system 2, and the service system is arranged to automatically incorporate that data in the database for preparation of the artwork. For example, in the case of a business card, the computer system of the user company may provide details from its database of the name, title, direct telephone line, e-mail, etc, of the person who is ordering the business card. This information is automatically provided and does not have to be entered by the person doing the ordering. All the person doing the ordering has to do is input any information which may vary from what is on the user company's system. The information gathering means (which may be software on the user computers system) will then provide the relevant information to the service system for producing the business card artwork. Information may be provided as a data stream or in any other convenient manner.

Further, in order that the user company can track the requisition process, when the order is complete the service system will return data to the user company's system which contains variable details pertinent to the order, labelled in a format which has been pre-specified by the user company.

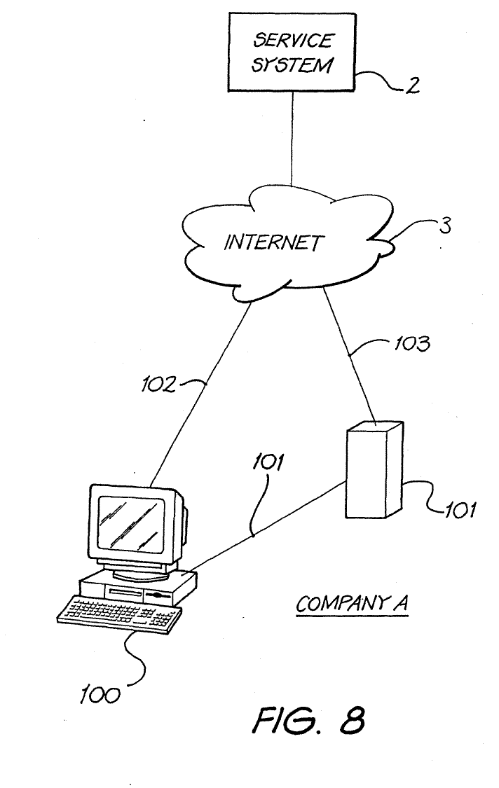

In a further embodiment of the present invention, the user may log on to a primary procurement system before being transferred to the service system, and preliminary steps in the order may take place between the user and the primary procurement system, before the user is linked to the service system 2. For example, a user in company A (FIG. 8) may log on via PC 100 and network link 101 (which could be any network link e.g. Internet) to company A's server 101 and receive a screen page which provides information on the preliminary steps in a print order process. The page may be a web-page. Preliminary order details may be generated to the company A server 101. At a predetermined stage within the order process, the user 100 is switched to the service system 2 via the Internet 3. The PC 100 may connect by a direct connection 102 to the Internet, if available, or via the company A server 101 via connection 103. In a preferred embodiment, the service system then provides web-pages to the user 100 which have the same “look and feel” of the initial procurement pages provided by server 101. The user, therefore, views the entire procurement system as seamless.

In a preferred embodiment, the server system 101, when switching to the service system 2, generates a URL string which points towards a service system 2 web-page. The URL string also contains variable labels, such as access codes, product codes, user codes and user information (name, address, etc) which can be used in the requisition procedure and also can be used to provide information for preparation of the artwork, as discussed above. When the order process of the service system 2 has been completed, a further URL string is generated in the service system, pointing back to the server 101, and this URL string may include details for company A's system to assist in tracking the order.

Note that the server system.101 may not belong to the same company as the user PC 100. In fact the server system 101 may be a printery or other entity which stores details of the printed matter which is required by a company and operates to print them. The user 100 therefore logs on via the Internet to the printer which then sources the service system 2 to provide the artworks. Printers could provide this type of interface for many customers.

A detailed procedure for implementing a system in which information is provided from a company system to assist with the preparation of the artwork is as follows:

1. As a first step, form structures are created within the service system for the customer company, the form structures are allocated a unique key number.

The key numbers are registered with the customers system and the product is identified as a product relating to the service system 2.

When subsequent system users browse to the service system product, the user system runs a query and produces a URL string pointing towards the service system page. This string contains access codes, product codes, user codes and user information (name, address, etc).

The service system 2 then detects the presence of variables in the URL string. If they are relevant for the form structure, they are captured and applied (and otherwise ignored).

If the access codes are authenticated, the service system 2 passes the incoming data (the URL string) to the first 2 pages created to process the order entry. These have the same “look and feel” as the customers ordering system.

The URL string will contain variables relevant to the ordering user (name, address, etc plus a number of the form structure and system variables).

The initial page will display the data in the appropriate data input fields (these have been set in the design of the form structure) allowing the user to modify and add information to the data input fields.

When the user is satisfied with the contents of the input fields they may preview an artwork. The user may then confirm the order.

The service system 2 then provides to the customer system a URL string (to a nominated page i.e. nominated by the customer) which contains the variable details pertinent to the order, labelled in the format specified by the customer. This assists with the customers requisition process.

The order then awaits approval.

The embodiment of the invention described above is intended particularly for the provision of forms which are to be printed by an external printery. The invention is not limited to this. It could be applied to the production of forms in-house within an organisation, e.g. via laser printers within a particular department.

Further, the invention is not limited to the provision of printed materials. In some cases, the invention could be utilised to produce finished electronic documents which are not intended to be printed but which are merely intended to be used electronically, e.g. transmitted over networks to intended recipients. The form structure in this case would contain relatively permanent material for an electronic document, which requires copy to be inserted before the electronic document can be transmitted.

The above description gives the example of the production of business cards. The present invention can be applied to any type of printed material, e.g. artwork for T-shirts, mugs, household items, stationery, advertisements, advertising catalogues, holiday catalogues, etc.

The preferred embodiment of the present invention operates via the Internet. It will be appreciated that this need not be the case. The system may operate via any wide area network. It may even operate within a company's Intranet.

As discussed in the preamble, the service may merely provide a database which the client user can log into to input data and commands for the production of an artwork. The client would be provided with a password to enable him to access the service. The client would therefore be able to provide databases containing relatively permanent material input by himself, for input of copy material by, for example, individuals in the client entity.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A multi-user, remotely accessible system for facilitating the production of forms, the system comprising:
a service computing system that is remotely accessible via a plurality of user clients' systems;
a form structure that has:
a database that is stored in memory in the service computing system;
at least one data component that is stored in a separate first data field in the database and is reproduced as multi-use visual material different finished artworks for a plurality of users; and
command components that are stored in the first data fields in the database and are used for generating the multi-use visual material in the different finished artworks;
a user client input;
copy information and commands that are received through the user client input, provide further visual material for the different finished artworks, and are stored in one or more second data fields that are separate from the first data fields; and
an artwork application that, upon command, automatically processes one or more of the data components and command components stored in the first data fields and the copy information and commands stored in the second data fields, visually arranging one or more of the data components and the copy information according to the stored commands to produce the desired finished artworks that re-use and visually reproduce at least some of the multi-use visual material stored in the first data fields and at least some of the further visual material stored in the second data fields.

2. A system in accordance with claim 1, further comprising a printer interface for access by one or more printer client systems, the printer interface adapted to access a completed artwork to produce printed forms, the printer interface further adapted to send an email alert to the one or more printer client systems, the email alert indicating that a completed artwork is available for printing.

3. A system in accordance with claim 2, wherein the user client system accesses the service computing system via the printer client system.

4. A system in accordance with claim 1, wherein the artwork application is further adapted to produce one or more of fractional fonts and different fonts on the same line by modifying the copy information input by a user.

5. A system in accordance with claim 4, wherein the copy information includes control information and the artwork application is further adapted to produce one or more of fractional fonts and different fonts on the same line by modifying the copy information according to the control information.

6. A system in accordance with claim 5, wherein the control information is stored in the database.

7. A system in accordance with claim 1, wherein the artwork application is further adapted to create an imposition plan utilizing imposition data and to impose the desired finished artwork on the imposition plan to enable printing of forms.

8. A system in accordance with claim 7, wherein the imposition data includes one or more of the following: (a) data on the size of the substrate that is to be used for a particular finished artwork; (b) data on the size of the item that is to be produced from the particular finished artwork; and (c) data on the type of cutting machine used by a particular printer to print the artwork.

9. A system in accordance with claim 1, wherein the service computing system is further adapted to automatically obtain information from the user client system for provision to the service computing system for preparation of the artwork, to obtain copy information from the client system, and to obtain data identifying one or more form structures stored by the service computing system.

10. A system in accordance with claim 9, wherein the information is transmitted within a URL string.

11. A system in accordance with claim 1, the service computing system being arranged to provide order information to the user client system to facilitate client tracking of form procurement.

12. A system in accordance with claim 1, wherein the data copy information and commands may be input into the database via the user client system.

13. A system in accordance with claim 1, wherein the desired finished artwork is a business card.

14. A system in accordance with claim 1, wherein the database is arranged to store control information for controlling the font.

15. A system for producing artwork, comprising:
a computing system that stores a form structure that comprises (a) a database, and (b) relatively permanent material stored as a plurality of components comprising data and commands separately stored within a respective plurality of first fields in a the database, at least some of the relatively permanent material being visual material to be reproduced in multiple different artworks;
means for inputting copy material to the form structure in the form of copy data to be input into second fields in the database;
an artwork producing application for processing the data and commands and copy data to produce a finished artwork that includes the copy material and the relatively permanent material, the artwork-producing application being programmed to use imposition data from the first fields in the database to produce an imposition plan that is used to produce the finished artwork that incorporates the imposition plan.

16. A method for facilitating the production of completed forms comprising:
storing a form structure as a plurality of components comprising data and commands that are separately stored within a respective plurality of fields within a database of a service system, the form structure including a first form structure key that identifies the form structure;
creating a URL at a customer system, the URL including a reference to the service system and one or more of copy data and a second form structure key, the copy data including control information for controlling a visual arrangement of the copy data on a completed form;
determining if the first form structure key matches the second form structure key;
if the first form structure key matches the second form structure key,
storing the copy data within one or more fields of the database,
applying the copy data to the corresponding form structure according to the control information, and
displaying the copy data in the completed form; and
if the customer system key number does not match the service system key number, discarding the copy data.

17. The method of claim 16, wherein the form structure includes one or more of reference point data that is indicative of reference points in space, artwork data that is indicative of artwork to be included in the completed form at a location on the completed form described by the reference point data, color data, and font data, wherein the artwork includes a reference to one or more of a graphic, a branding image, a company logo, a text, a video, or an audio recording.

18. The method of claim 17, wherein the color data and the font data are indicative of a color and a font of the copy data.

19. The method of claim 17, further comprising communicating the graphic, the branding image, the company logo, the text, the video, or the audio recording from a remote location.

20. The method of claim 17, further comprising, if the first form structure key matches the second form structure key, displaying the copy data and the artwork in the completed form.

21. The method of claim 16, further comprising storing the copy data in one or more of a plurality of fields within the database; and
modifying the control information of the stored copy data to alter one or more of a font, line spacing, and alignment of the copy data within the completed form.

22. The method of claim 16, wherein the database includes default control information; and
if the first form structure key matches the second form structure key, applying the copy data to the corresponding form structure according to the default control information.

23. A system in accordance with claim 7, wherein the imposition data is stored in data fields in the database.

24. A system in accordance with claim 1, in which each form structure is used to generate a different finished artwork for each of a plurality of different users.

25. A system in accordance with claim 15, in which each form structure is used to generate a different finished artwork for each of a plurality of different users.

26. A system in accordance with claim 16, in which each form structure is used to generate a different finished artwork for each of a plurality of different users.
